(19) United States
(12) Patent Application Publication
(10) Pub. No.: US 2019/0166892 A1
(43) Pub. Date: Jun. 6, 2019

(54) Methods to produce Plant protein lectin eliminated legumes,and or nuts, and or seeds, and products therefrom

(71) Applicant: Daniel William Harrell, Miami, FL (US)

(72) Inventor: Daniel William Harrell, Miami, FL (US)

(21) Appl. No.: 15/832,215

(22) Filed: Dec. 5, 2017

(51) Int. Cl. A23L 11/30; A23L 11/00; A23L 25/00; A23L 7/196; A23L 5/20; A23L 5/00; A23P 20/10

(52) U.S. Cl. CPC A23L 11/31; A23L 11/01; A23L 25/25; A23L 7/1963; A23V 2002/00; A23L 5/55; A23P 20/105; A23P 20/11; A23L 5/21

(57) ABSTRACT

The present invention relates to legumes, and or nuts, and or seeds, and products containing the legumes, nuts and or seeds and to their methods of preparation. More particularly, the present invention is directed towards eliminating plant protein lectins in legumes, and or nuts, and or seeds and to the methods of preparation. Plant lectins are proteins produced by plants as a poisonous defense, and found in many of the foods we eat containing nuts and or legumes and or seeds. Everyday people enjoy eating snacks like; health/nutrition bars, candy bars, soy beans, cashews or even a can of peanuts containing the plant protein lectins. Many of whom are having adverse effects from plant protein lectins.

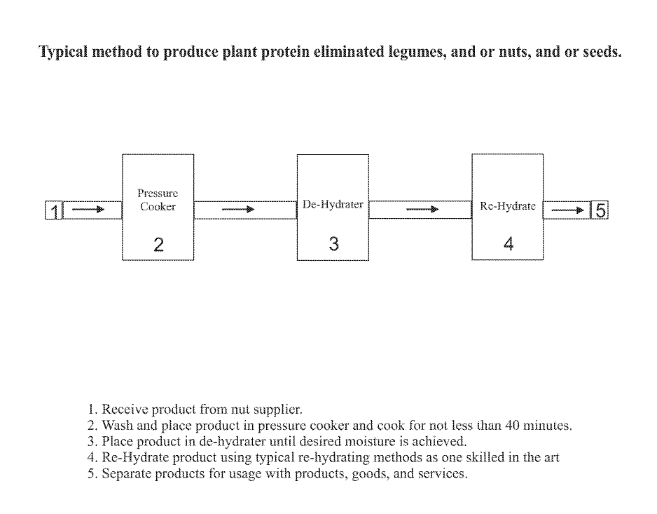

In the Present Invention, the legumes, and or nuts, and or seeds are processed using methods unused and unknown to one skilled in the art. Resulting in legumes, and or nuts, and or seeds in which the plant protein lectins are removed. And these processed legumes, and or nuts, and or seeds are further processed to accept various coatings used in the trade and directed towards providing multiple edible products containing legumes, and or nuts, and or seeds free of plant protein lectins. Food products including but not limited to, dough, health bars, cereals, yogurt, pastries, ice cream, and the like, as well as pet foods and animal feeds. Another process, the different products are packaged for consumer consumption and/or commercial uses. Also provided are typical methods used for production of these products in the art.

### FIELD OF THE INVENTION

The present invention relates to a novel process to remove plant protein lectins from legumes and/or nuts and/or seeds, and the methods of preparation for use in snacks. More particularly, the present invention is directed towards consumer edible products containing legumes and or nuts and or seeds and improving the quality of the legumes and or nuts and or seeds, such as whole seeds, legumes, or nut meats or slices, and blends of such nuts, legumes, or seeds by a pressure cooking process to remove the plant lectins, then a dehydrating process to remove water, then the legumes and/or nuts and/or seeds are and optionally rehydrated, still another option of adding a coating of microcrystalline cellulose or similar in the art when applicable, and then by providing the nut, legume, or seeds, pieces or whole, with additional processes to create the nutritional snacks, and yet a final process of packaging.

### BACKGROUND OF THE INVENTION

Legumes, nuts, seeds, have been used in consumer products for many years, such products as nutritional bars, cereals, mixed containers roasted nuts/snacks. Traditionally commercial manufacture uses the most efficient processes to fabricate the various snacks/foods.

For instance; methods to produce roasted peanuts was revised by Buhler Aeroglide, in the Study of peanut allergies, by the National Institute of Allergies and Infectious Disease. http://dx.doi.org/10.010/j.jaci.2016.10.010. (ref: 1)The report states a revised method to dry roast that significantly reduces the risk of salmonella contamination. The method is to create more air volume in the commercial ovens used. In the past pressure cooking was seldom used for the duration of no more than three to five minutes and then roast the nuts or beans. This method has long been vacated being very costly and it reduced the snap and flavor of the nuts, newer methods results in a more cost effective product not using pressure cooking. In the Study given by Peanut Science www.peanutscience.com/doi/abs/10.3146/ps13-21.1, (ref: 2) namely: Salmonella surrogate reduction using industrial using peanut dry roasting parameters are explored. Another method used in preparing beans for home use of beans containing plant protein lectins is; to soak beans all day only reducing the plant protein lectins, wash, and cook for the desired texture.

In U.S. Pat. Nos. 2,003,415 to Ammann and 3,294,549 to Vix et al., (ref 3), procedures for pressing the oil from nuts such as peanuts are described. Broadly, these methods include the steps of pressing nuts until the desired quantity of fully digestible triglyceride fats are removed and then steaming or cooking the partially defatted nuts in water until the nuts are reconstituted to substantially their original size and shape.

U.S. Pat. No. 4,466,987 to Wilkins et al. (ref: 4), relates to the production of low fat nuts prepared by moistening, initially roasting, pressing, hydrating, and finally roasting.

In air roasting, the nuts are roasted in a stream of hot air at a temperature of about 275.degree. F. to about 400.degree. F., advantageously about 320.degree. F. to about 335.degree. F. Roasting times and temperatures can be varied depending upon the particular type of nut being processed, as well as the roasting temperature and degree of roasting desired. Illustratively, the time and extent of roasting will be greater for peanuts (i.e., about 10 minutes to about 30 minutes) than for cashews (i.e., about 3 minutes to about 15 minutes). The most appropriate conditions to be adopted in any particular instance can be readily determined by the skilled artisan.

In granular roasting, the nuts are contracted with a finely divided heat transfer media which is heated to a temperature of about 315.degree. F. to about 465.degree. F., preferably about 380.degree. F. to about 410.degree. F. Roasting times and temperatures will vary depending upon the particular type of nut being processed and the degree of roasting desired. Illustratively, the time and extent of roasting will be greater in the case of peanuts (i.e., about 1 minute to about 9 minutes), than in the case of cashews (i.e., about 30 seconds to about 3 minutes)

The current methods used, only reduces the plant protein lectins from a 20,000 IU count to a level somewhere between 700 IU to 400 IU count and in no way eliminates plant protein lectins. In the study by Dr. Steven Gundry he shows plant protein lectins remaining in peanuts, legumes, and seeds, after the usual methods incurred by manufactures or consumers of the foods containing these plant proteins lectins are affecting the health of many consumers using products containing plant lectins.

He also teaches us the only way to eliminate plant protein lectins from legumes, nuts, and seeds containing the plant lectins is to pressure cook the legumes, nuts, and seeds for a duration of not less than 40 minutes. Dr. Gundry's Diet revolution 2008 and again in 2017 in the plant paradox (ref: 4), with the knowledge of the dangers of the plant protein lectins, these plant protein lectins should be considered dangerous and avoided. There are many foods containing the legumes, nuts, and seeds containing plant protein lectins.

Unfortunately, nothing in the prior art has been shown to produce legumes, and or nuts, and or seeds which have eliminated plant protein lectins. The plant lectin eliminated legumes, and or nuts, and or seeds will have the taste and texture obtained from products currently sold to consumers containing legumes, and or nuts, and or seeds, such as peanuts sold at sporting events and other like venues. It has now been found, surprisingly, that the use of products containing plant protein lectin eliminated legumes, and or nuts, and or seeds can achieve a health benefit.

### BACKGROUND ART

In U.S. Pat. No. 3,314,800, Noznick et al. discuss the application of salt to nuts, and attempt to overcome the problem of poor salt adherence by first dry roasting nuts and then applying a coating of wheat gluten to the nuts while still hot. Noznick et al. further suggests the application of salt and gluten in a single wet phase. The method of this patent has several drawbacks, including the undesirable requirement of coating the nuts while still hot and the limited number of seasoning which can be combined with gluten in a single wet phase. Salt can then be applied either with the gluten or thereafter.

Wilkins et al., in U.S. Pat. No. 4,769,248, disclose the application of a starch pre-dust, a coating of a gelatin solution and then a coating of a seasoning mix which may contain salt prior to dry roasting the nuts. These nuts show superior coating adherence of the seasoning mix applied thereto. Similarly, Herbert et al. teach the application of a gelatin powder, followed by a gelatin solution in order to increase the adherence of a coating of a seasoning mix which may contain salt, in U.S. Pat. No. 5,149,562.

In U.S. Pat. No. 4,206,246, Mamahit discloses immersing peanuts in brine which had been boiling and is then cooled to just below the boiling point, and which may contain various flavorings. The nuts are then oil roasted.

Typically, the nuts are roasted to a moisture content of less than about 3% preferably less than about 2%, and most preferably about 1.5% or less.

For example, in U.S. Pat. Nos. 2,003,415 to Ammann and 3,294,549 to Vix et al., procedures for pressing the oil from nuts such as peanuts are described. Broadly, these methods include the steps of pressing nuts until the desired quantity of fully digestible triglyceride fats are removed and then steaming or cooking the partially defatted nuts in water until the nuts are reconstituted to substantially their original size and shape.

U.S. Pat. No. 4,466,987 to Wilkins et al. relates to the production of low fat nuts prepared by moistening, initially roasting, pressing, hydrating, and finally roasting.

In air roasting, the nuts are roasted in a stream of hot air at a temperature of about 275.degree. F. to about 400.degree. F., advantageously about 320.degree. F. to about 335.degree. F. Roasting times and temperatures can be varied depending upon the particular type of nut being processed, as well as the roasting temperature and degree of roasting desired. Illustratively, the time and extent of roasting will be greater for peanuts (i.e., about 10 minutes to about 30 minutes) than for cashews (i.e., about 3 minutes to about 15 minutes). The most appropriate conditions to be adopted in any particular instance can be readily determined by the skilled artisan.

In granular roasting, the nuts are contracted with a finely divided heat transfer media which is heated to a temperature of about 315.degree. F. to about 465.degree. F., preferably about 380.degree. F. to about 410.degree. F. Roasting times and temperatures will vary depending upon the particular type of nut being processed and the degree of roasting desired. Illustratively, the time and extent of roasting will be greater in the case of peanuts (i.e., about 1 minute to about 9 minutes), than in the case of cashews (i.e., about 30 seconds to about 3 minutes).

### SUMMARY OF THE INVENTION

The present invention is unique in the technique and methods to process and produce plant protein lectin eliminated legumes, and nuts and seeds for consumer and commercial use.

Many people enjoy eating different products containing legumes, and or nuts, and or seeds, unknowingly containing poisonous plant lectins (ref: 6). Plant protein lectins have been historically tolerated and given little or no attention of the ill effects after consumption. As often observed the usual method for cooking legumes is to place the legumes in a pot of water and soak them all day and after cook them. This is the standard procedure consumers have often used, only to reduce the plant protein lectins in the legumes, and nuts, and seeds. Products containing these plant protein lectins are produced for consumption commercially without any methods or concerns with reducing plant protein lectins. Reduced plant protein lectins throughout history have been unknowingly acceptable to consumers and commercial users of these plant protein lectin containing products. Some examples of consumer plant protein lectin, containing foods are; peanut butter, nutritional bars, cereals, or a can of cashews and many others. Recent studies have raised awareness of plant protein lectin harms, negative effects on health, and researched extensively by Dr. Steven Gundry (ref: 5). The Present Invention relies upon a physical process of which eliminates all plant protein lectins in legumes, and or nuts and or seeds and processes for use in various consumer products. Legumes, and or nuts, and or seeds are pressure cooked for a duration of not less than 40 minutes and further processed the legumes, and or nuts, and or seeds are de-hydrated and still further optionally processed to re-hydrated and or optionally provided with a coating of microcrystalline cellulose or similar to the trade, and or optionally coated with a confectioner's coating. The Present Invention exhibits significantly higher process times and lower yields than the prior art processes. The process of pressure cooking has rarely been used in the past and abandoned in the process of roasting, however the duration of time previously used was 10 to 15 minutes at longest and proved to be costly. The process of the present invention is currently unused and unknown to one skilled in the art. The process comprises; legumes, and or seeds, and or nuts are provided with a process of pressure cooking for not less than 40 minutes to remove the plant protein lectins, and additionally processed with a dehydration method and still additionally yet another process of re-hydration, and an optional confectioner's coating material may be applied, an optional coating of microcrystalline cellulose or similar, in an amount effective to mitigate agglomeration, bridging or weeping of the pieces applied. Rather, plant protein lectin eliminated legumes, and or nuts, and or seeds of the present invention are less sticky and readily separated from one another using ordinary gravity feed handling conditions. Further, the dried or re-hydrated legumes and/or nuts and or seeds are not significantly altered in flavor or appearance by use of the microcrystalline cellulose or similar.

The coated pieces thus are not unduly sweetened or otherwise modified by the present coating. The plant protein lectin eliminated legumes, and or seeds, and or nuts or blends of the present invention also exhibit a surprising handling shelf life, meaning that the plant protein lectin eliminated legumes, and or seeds, and or nuts and or blends can be stored for prolonged periods of time with minimal blocking.

The coated and or uncoated legumes and or nuts, and or seeds can also include a topical coating such as a fat or sugar based coating or seasoning blend. The thus treated plant protein lectin eliminated legumes and or nuts and or seeds are useful as a consumable food product by itself, or can be mixed with additional food components to provide a combination food product whether in the form of a loose aggregate such as a mixed container of peanuts, e.g., with raisins and/or pretzels, or in the form of a solid agglomeration such as a granola bar or even as a spread.

What is claimed is:

1. A method of preparing plant protein lectin eliminated legumes, and or nuts and or seeds, whole and or pieces comprising: a) placing an order for legumes, nuts and or seeds, whole and or pieces with a nut supplier, receiving shipment of legumes, and or nuts and or seeds; b) conducting further processing operations, the legumes, and or nuts and or seeds, are washed and placed in a pressure cooker; c) conducting further processing operations, adding in the appropriate amount of water in the pressure cooker; d) conducting further processing operations, adding the desired amount of oil to the water in the pressure cooker; e) conducting further processing operations, pressure cook the legumes, and or nuts and or seeds for a duration of not less than 40 minutes thus eliminating plant protein lectins contained in the legumes, and or nuts and or seeds; 0 conducting further processing operations, remove and rinse the plant lectin free legumes, and or nuts and or seeds and; g) conducting further processing operations, the plant lectin free legumes, and or nuts and or seeds are processed to remove water or de-hydrate to a desired moisture amount; h) conducting further processing operations, the de-hydrated plant lectin free legumes, nuts and or seeds; are optionally processed to re-hydrate; I) conducting further optional processing operations the de-hydrated, and or re-hydrated plant lectin free legumes, nuts and or seeds are processed with a microcrystalline cellulose or similar used in the trade; j) and conducting further processing operations; separate the plant lectin free legumes, and or nuts and or seeds, for use with the desired product; k) conducting further optional processing operations, the plant lectin free legumes, nuts and or seeds; add confectioner's coating or seasoning; l) still further processes, package the plant lectin free legumes, nuts and or seeds, whole and or pieces, re-hydrated or de-hydrated, coated or uncoated, either alone or in combination with other products or in combination with additional food components to provide various combination food products.

2. A method of preparing plant lectin free legumes and or nuts and or seeds, whole and or pieces of claim 1, wherein the legumes, nuts and or seeds, whole and or pieces are mixed with additional food components to provide a combination food product, with the additional food components being a confectioner's coating. The confectioner's coating material may be based upon cocoa butter or it may be a compound coating. The latter coating materials are based upon hardened vegetable oils.

3. A method of preparing plant lectin free legumes, and or nuts and or seeds; whole and or pieces of claim 2, wherein the coated legumes, and or nuts, and or seeds, whole and or in part are mixed with additional food components to provide a combination food product, whereas the combination food product is; coated legumes, and or nuts and or seeds whole and or in part having an added coating of microcrystalline cellulose or similar used in the trade, an amount effective to minimize nut oil transfer from the legumes, nuts and or seeds pieces during storage.

4. The coated legumes, and or nuts and or seeds whole and or in part of claim 3, wherein the microcrystalline cellulose or similar used in the trade, has an average particle size of from .apprxcq.50 to .apprxeq.250 microns.

5. The coated legumes, nuts and or seeds whole and or in part of claim 4, wherein the microcrystalline cellulose or similar used in the trade, is present at a coating weight of from .apprxeq.1 to .apprxeq.10 grams per kilogram of the legumes, and or nuts and or seeds pieces.

6. The coated legumes, nuts and or seeds whole and or in part of claim 4 wherein at least a portion of the coated legumes and or nuts and or seeds, whole and or in part includes a fat or sugar based coating.

7. A method of preparing plant lectin free legumes and or nuts and or seeds; whole and or pieces of claim 6, wherein the coated legumes and or nuts and or seeds; whole and or in part are mixed with additional food components to provide a combination food product, whereas the combination food product is;
container of coated legumes, and or nuts, and or seeds, and or fruits, and or other food products.

8. A method of preparing a combination food product of claim 1 comprising: after processing or partial processing thereof, the legumes, and or seeds, and or nuts, and applying a dry coating of microcrystalline cellulose or similar used in the trade to the legumes, and or nuts and or seeds whole and or in part in an amount effective to minimize nut oil transfer from the legumes and or nuts and or seeds whole and or in part during storage; and mixing the “non”-confectioner's coated, legumes, and or nuts and or seeds pieces with additional food components to provide a combination food product, where the combination food product is; container of non-confectioner's coated legumes, and or nuts, and or seeds, and or fruits, and or other food products.

9. A method of preparing plant lectin free legumes, and or seeds, and or nuts, whole and or pieces of claim 1, wherein the legumes, and or seeds, and or nuts, whole and or in part are mixed with additional food components to provide a combination food product, whereas the combination food product is; a container of de-hydrated or re-hydrated, uncoated/raw legumes, and or seeds, and or nuts, and or fruits and or other food products, seasoned or non-seasoned.

10. A method of preparing plant lectin free legumes, and or seeds, and or nuts, whole and or pieces of claim 9, wherein the legumes and or nuts, whole and or in part are mixed with additional food components to provide a combination food product, whereas the combination food product is; a spread similar in nature to peanut butter, having a smooth or textured appearance.

11. A method of preparing plant lectin free legumes and or nuts, and or seeds, whole and or pieces of claim 1, wherein the non-confectioner's coated legumes and or nuts, and or seeds, whole and or in part, de-hydrated and or rehydrated are mixed with additional food components to provide a combination food product, whereas the combination food product is an; energy/nutrition bar combining, legumes, and or nuts, and or seeds, and or fruits, and or other food products.

12. A method of preparing plant lectin free legumes and or nuts, and or seeds whole and or pieces of claim 2, wherein the confectioner's coated legumes and or nuts and or seeds, whole and or in part are mixed with additional food components to provide a combination food product, whereas the combination food product is an energy/nutrition bar combining, plant lectin free legumes, and or nuts and or seeds, and or fruits, and or other food products.

13. A method of preparing plant lectin free legumes and or nuts and or seeds, whole and or pieces of claim l, wherein the legumes and or nuts and or seeds; are processed to remove water and are de-hydrated and are processed to de-hydrate to a desired moisture content, using typical methods or similar processes known and used by one skilled in the art.

14. In one method of preparing plant lectin free legumes and or nuts and or seeds, whole and or pieces of claim 1, wherein the legumes and or nuts and or seeds, whole and or in part are processed to de-hydrate and legumes and or nuts and or seeds, whole and or pieces, after de-hydrated the uncoated legumes, and or nuts, and or seeds, are provided with a coating of microcrystalline cellulose or similar in the art in an amount effective to mitigate agglomeration, bridging or weeping of the pieces.

15. A method of preparing plant lectin free legumes and or nuts and or seeds, whole and or in part of claim 1, wherein the legumes and or nuts and or seeds, whole and or in part are re-hydrated and are re-hydrated with a typical re-hydrating agents such as however not limited to; extra virgin olive oil, coconut oil, corn oil, cottonseed oil, palm oil, peanut oil, canola oil, safflower oil, sesame oil, sunflower oil, almond oil, beech nut oil, cashew oil, hazelnut oil, pecan oil, pine nut oil, pistachio oil, walnut oil, grape seed oil, pumpkin seed oil, watermelon seed oil, or any combination of the foregoing. Using typical methods or similar processes known and used by one skilled in the art.

16. A method of preparing legumes and or nuts and or seeds, whole and or pieces of claim 1, wherein the legumes and or nuts and or seeds, whole and or in part are pressure cooked for the duration of not less than 40 minutes. Using typical methods or similar processes known and used by one skilled in the art.

17. A method of preparing plant lectin free legumes and or nuts and or seeds, whole and or pieces of claim 15, wherein the legumes and or nuts and or seeds, whole and or in part are re-hydrated and are re-hydrated with a typical re-hydrating agents mixed with additional food components to provide a combination food product, with the additional food components being a topical coating such as a fat or sugar based coating or seasoning blend.

18. In one method of preparing plant lectin free legumes and or nuts and or seeds, whole and or pieces of claim 1, wherein the legumes and or nuts and or seeds, whole and or in part are processed to de-hydrate and the legumes and or nuts and or seeds, whole and or pieces, after dehydrated are provided with additional food components to provide a combination food product, with the additional food components being a topical coating such as a fat or sugar based coating or seasoning blend.

19. A method of preparing plant lectin free legumes and or nuts and or seeds; whole and or pieces of claim 1, wherein the plant lectin free legumes, and or nuts, and or seeds products; whole and or in part are packaged using typical methods or similar processes known and used by one skilled in the art.

20. A method of preparing plant lectin free legumes and or nuts and or seeds; whole and or pieces of claim 1, wherein the plant lectin free legumes and or nuts and or seeds products are placed in a pressure cooker; and are washed and placed in said pressure cooker free and clean of any debris.

21. A method of preparing plant lectin free legumes and or nuts and or seeds; whole and or pieces of claim 20, wherein the plant lectin free legumes and or nuts and or seeds products are placed in a pressure cooker; and the amount of water is added according to the specifications of the manufacture of the machine used by one skilled in the art.

22. A method of preparing plant lectin free legumes and or nuts and or seeds; whole and or pieces of claim 20, wherein the plant lectin free legumes and or nuts and or seeds products are placed in a pressure cooker, the proper amount of water is added; and the desired amount of oil is added to prevent extreme loss of oil in the product. Typical oils used but not limited are; coconut, soybean, palm, and peanut oils.

23. A method of preparing plant lectin free legumes and or nuts and or seeds; whole and or pieces of claim 16, wherein the plant lectin free legumes and or nuts and or seeds products are pressure cooked for not less than 40 minutes; product is then removed and rinsed to remove any excess debris, such as but not limited to, plant protein lectins.

24. A method of preparing plant lectin free legumes and or nuts and or seeds; whole and or pieces of claim 16, wherein the plant lectin free legumes and or nuts and or seeds products are pressure cooked for not less than 40 minutes; product is then removed and rinsed; The products are separated for different uses, wherein the composition is in a form selected from the group consisting of: a peanut butter type spread, an energy bar, a protein bar, a candy, a cereal, a nutrition bar, a legume, and or nut, and or seed blend coated or un-coated, dough, health bars, cereals, yogurt, pastries, ice cream, and the like, as well as pet foods and animal feeds, the products are then separated and packaged for commercial use.
